(19) United States
(12) Patent Application Publication
(10) Pub. No.: US 2006/0203413 A1
(43) Pub. Date: Sep. 14, 2006

(54) Protection circuit enabling a load to withstand a transient power supply failure

(75) Inventors: Daniel Peron, Lannion (FR); Gilbert Lucas, Lannion (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/368,396

(22) Filed: Mar. 7, 2006

(30) Foreign Application Priority Data
Mar. 8, 2005 (EP) 05300170.7

(51) Int. Cl. H02H 9/06

(52) U.S. Cl. 361/118

(57) ABSTRACT

A protection circuit (PD1) enables a load (L) to withstand a transient power supply failure. It comprises: inputs connected to at least one electrical power supply (B1, B2), outputs connected to the load (L), at least two storage capacitors (SC1, SC2), and first switching means (D1 to D4, SW3, CU) such that the two storage capacitors are:

connected in parallel to at least one power supply (B1, B2) when the voltage of at least one power supply is greater than a fixed value; and

isolated from any power supply (B1, B2) and connected in series to the outputs of the circuit (PD1) when the voltage of each power supply is less than or equal to the fixed value. Application to electronic equipment, in particular telecommunications equipment.

The invention relates to a protection circuit enabling a load to withstand a transient power supply failure. A circuit of the above kind is usable in particular in telecommunications switching equipment that needs to have a power supply voltage that is always higher than a set minimum value. Telecommunications equipment of this kind consists of electronic cards inserted into connectors on a backplane that supplies electrical power to a plurality of cards, generally at a voltage of 48 V DC.

All the cards are connected in parallel in order to supply them with power. If a short-circuit on a card short-circuits the power supply input of the card, a fuse specific to that card is blown. This disconnects the card from the power supply after a time-delay of the order of a few milliseconds. Because of the short-circuit, the voltage of the power supply might be practically zero during this time-delay. The cards are all supplied with power in parallel and cannot operate correctly during this time-delay unless they are protected against this kind of transient power supply failure.

The cards generally include a plurality of filter capacitors connected in parallel to the power supply input of the card and a DC-DC converter for converting the voltage of 48 V into one or more lower DC voltages, for example 5 V and 3.3 V. This converter can function correctly only in a well-defined input voltage range, for example from 36 V to 72 V.

The power supply inputs of the cards are connected to the power supply (or supplies) by a switching system generally consisting of diodes so that the filter capacitors can charge when the power supply is operating correctly and cannot discharge when the power supply is short-circuited. To overcome power supply failure, there are generally two supplies connected in parallel by diodes.

To prevent the voltage at the input of the converter dropping below the permitted minimum value during a transient power supply failure, the capacitance of the filter capacitors can be increased in order for them to store sufficient charge for the input voltage of the converter to remain above the minimum value throughout the duration of the fault. This is known in the art The filter capacitors shunting the power supply input of each card have a very high total capacitance, for example 10000 microfarads (μf) in the case of a card consuming 200 watts (W). The volume occupied by these capacitors is therefore very large and the capacitors significantly increase the cost of the card.

U.S. Pat. No. 5,973,547 describes a voltage regulator having inputs connected to an electrical power supply, outputs connected to a load, two storage capacitors, switching means, and control means for the switching means. The two storage capacitors are:

connected in parallel to at least one power supply when at least one power supply is operating normally; and

isolated from any power supply and connected in series to the outputs of the regulator when no power supply is operating normally.

That regulator protects the load against a voltage drop because the series connection of the two storage capacitors temporarily creates a supply whose initial voltage is theoretically equal to the sum of the voltages to which the two capacitors are charged.

The object of the invention is to improve the above prior art circuit.

A protection circuit according to the invention enabling a load to withstand a transient power supply failure including:

inputs connected to at least one electrical power supply and outputs connected to the load; and

at least two storage capacitors, first switching means and control means for the first switching means, such that the two storage capacitors are:
connected in parallel to at least one power supply when at least one power supply is operating normally; and
isolated from any power supply and connected in series to the outputs of the circuit when no power supply is operating normally;

is characterized in that:

a first storage capacitor has a first terminal connected to a positive output of the circuit and a second terminal connected to the negative output of the circuit by a first resistor;

a second storage capacitor has a first terminal connected to the negative output of the circuit and a second terminal connected to the positive output of the circuit by a second resistor; and

an electronic switch connects the second terminal of the first storage capacitor to the second terminal of the second storage capacitor; and

in that the first control means include switch control means such that the switch closes when no power supply is operating normally and the switch opens when at least one power supply is operating normally.

The circuit characterized as above has the advantage of including only one electronic switch instead of the three switches of the prior art circuit disclosed in U.S. Pat. No. 5,973,547 whilst retaining the same protection against voltage drops.

The invention can be better understood and other features thereof become apparent in the light of the following description and the accompanying drawings:

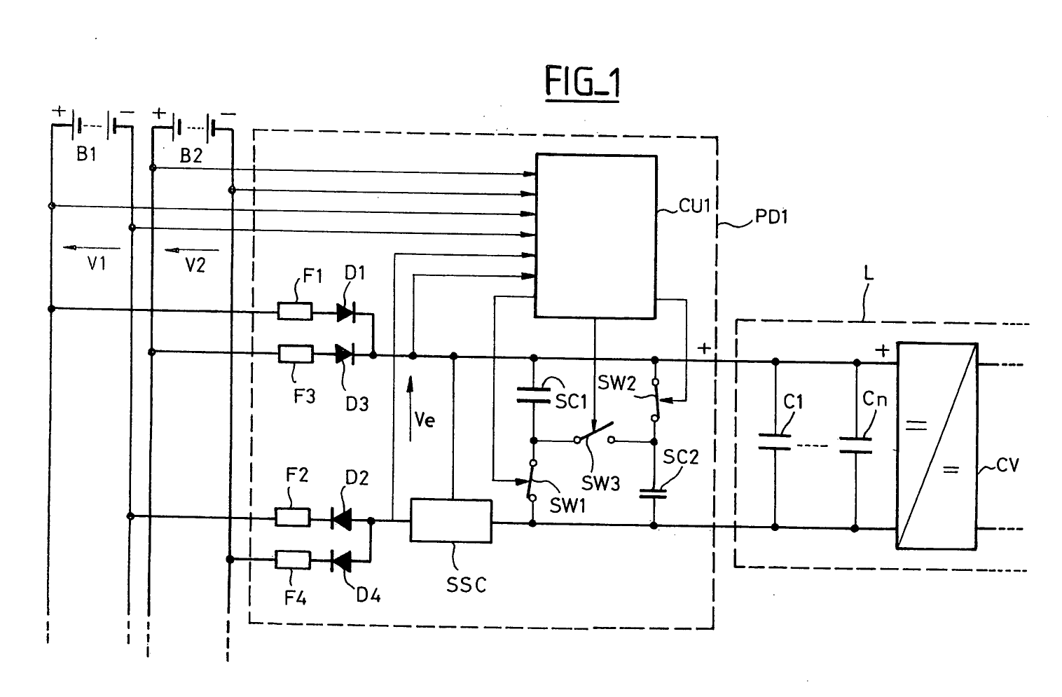

FIG. 1 is a block diagram of one embodiment of a prior art protection circuit in the state it assumes when the power supply is operating normally.

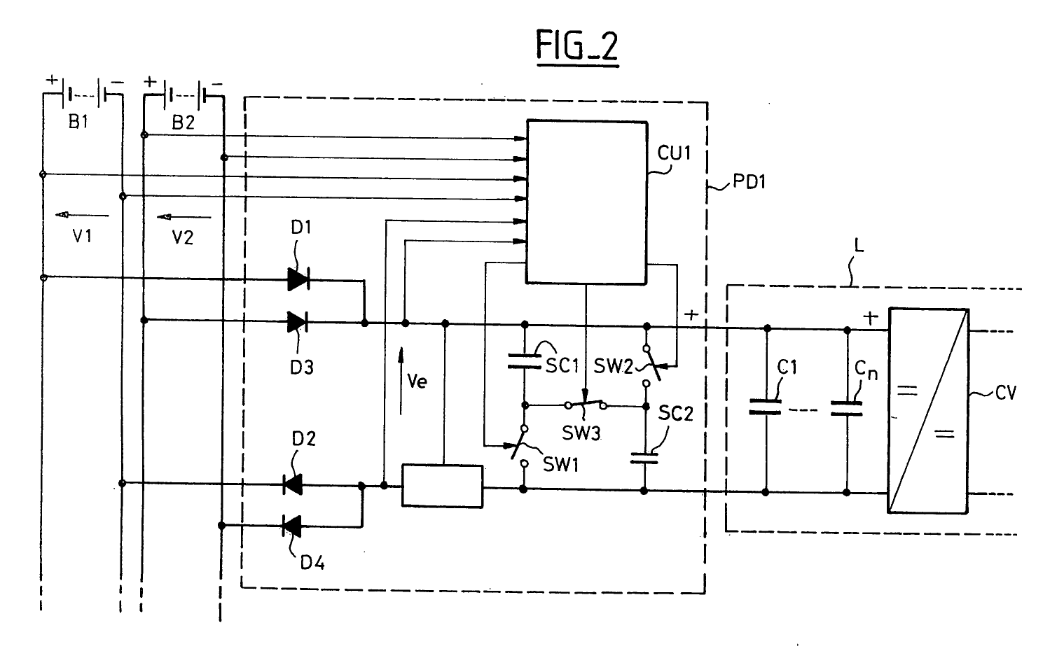

FIG. 2 is a block diagram of the same embodiment of the prior art circuit in the state it assumes in the event of a power supply failure.

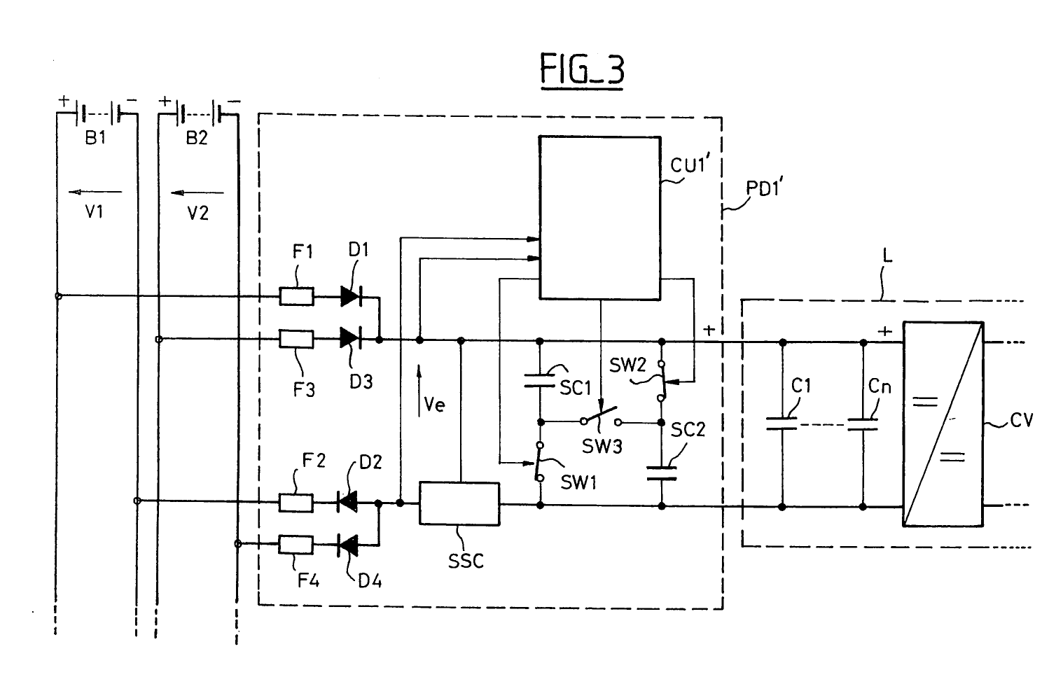

FIG. 3 is a block diagram of a variant of the above embodiment of the prior art circuit including a different control unit.

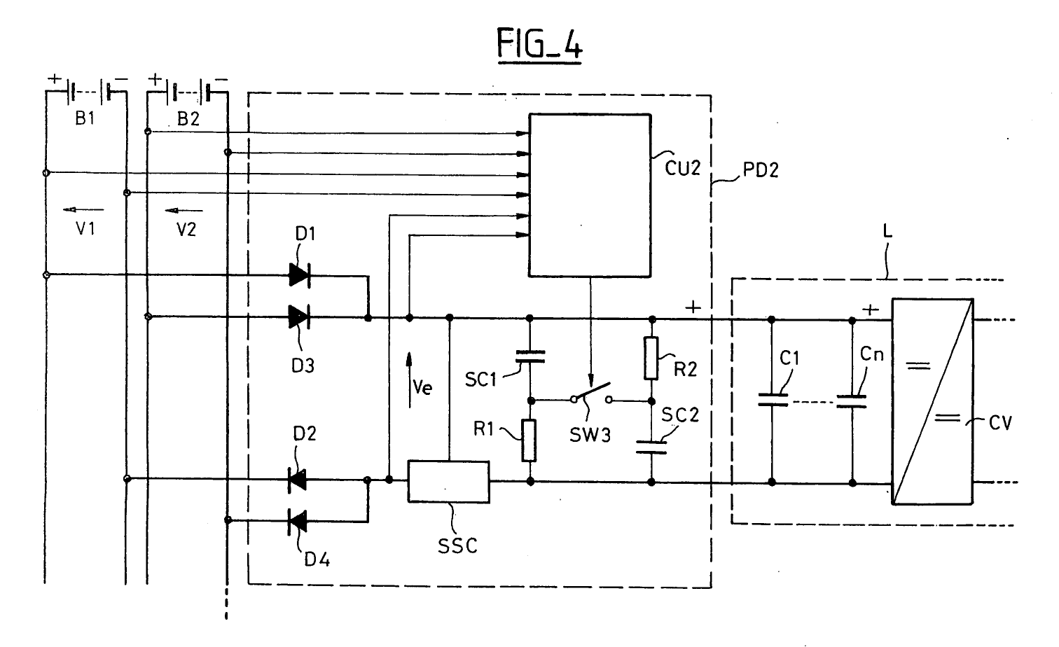

FIG. 4 is a block diagram of one embodiment of a protection circuit of the invention in the state it assumes when the power supply is operating normally.

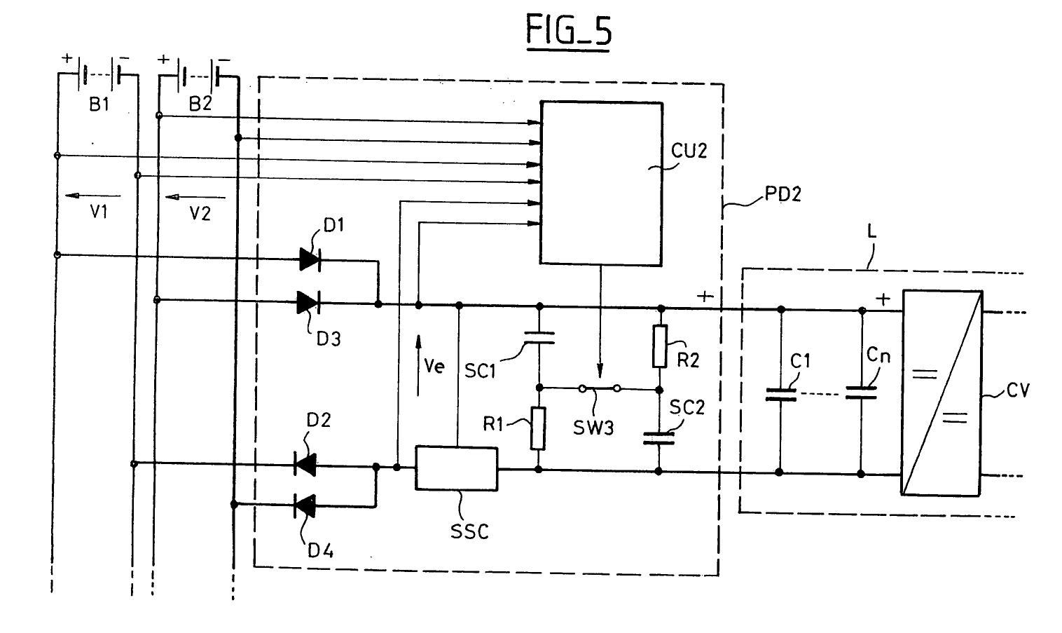

FIG. 5 is a block diagram of the same embodiment of the protection circuit of the invention in the state it assumes in the event of a power supply failure.

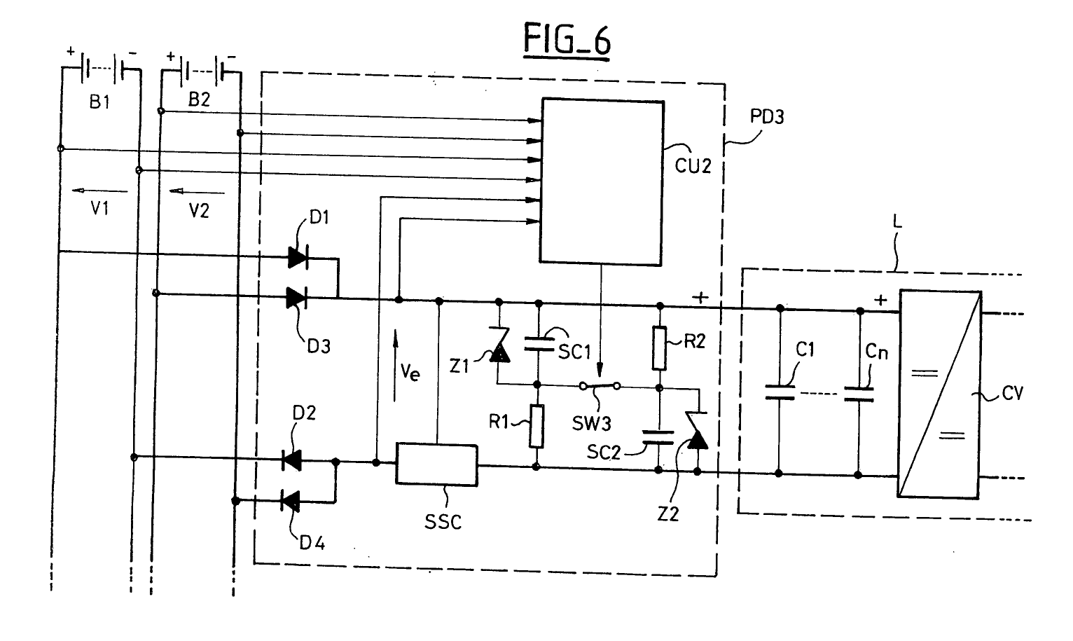

FIG. 6 is a block diagram of one variant of the above embodiment of the protection circuit of the invention.

FIG. 1 shows an embodiment of the prior art circuit PD1, which has:

two positive inputs connected to positive terminals of two power supplies B1 and B2, respectively;

two negative inputs connected to negative terminals of the two power supplies B1 and B2, respectively;

two diodes D1 and D3 the anodes whereof are connected to respective positive inputs via a fuse F1 and a fuse F3, respectively;

two diodes D2 and D4 the cathodes whereof are connected to respective negative inputs via a fuse F2 and a fuse F4, respectively;

a positive output and a negative output connected to a positive input and a negative input, respectively, of a load L, the positive output being connected to the cathodes of the diodes D1 and D3;

a slow-start circuit SSC having three ports connected to the positive output of the circuit PD1, to the negative output of the circuit PD1, and to the anodes of the diodes D2 and D4, respectively;

a storage capacitor SC1 having a first terminal connected to the positive output of the circuit PD1 and a second terminal connected to the negative output of the circuit PD1 by an electronic switch SW1;

a storage capacitor SC2 having a first terminal connected to the negative output of the circuit PD1 and a second terminal connected to the positive output of the circuit PD1 by an electronic switch SW2;

a third electronic switch SW3 connecting the second terminal of the capacitor SC1 to the second terminal of the storage capacitor SC2; and

a control unit CU1 having:
outputs connected to respective control inputs of the electronic switches SW1, SW2, SW3;
two pairs of inputs connected to the terminals of the supply B1 and to the terminals of the supply B2, respectively; and
a third pair of inputs connected to the cathodes of the diodes D1 and D3 and to the anodes of the diodes D2 and D4.

The load L is an electronic card, for example, carrying a series of filter capacitors C1 to Cn and a DC/DC converter CV all connected in parallel to the two inputs of the load L.

The slow-start circuit SSC is a standard electronic circuit the function whereof is to limit the current surge caused by the charge in the downstream capacitors, in particular the capacitors SC1, SC2, C1 to Cn, upon inserting the card into a backplane or switching on the backplane.

The supplies B1 and B2 consist of two 48 V batteries charged continuously by chargers (not shown) supplied with power from the mains. They supply in parallel a plurality of loads like the load that is the only one represented. Each load that necessitates protection against transient power supply failure is connected to the two supplies B1, B2 by a circuit analogous to the circuit PD1. The diodes D1 to D4 back up a first supply (for example B1) by means of the other supply (B2) in the event of a permanent failure affecting the first supply. On the other hand, these diodes cannot prevent a power supply failure if one of the other loads connected in parallel to the two supplies is short-circuited. A short-circuit may cause the voltages of the two supplies B1 and B2 to fall simultaneously. It is at this point that the control unit CU intervenes, this unit measuring continuously:

the voltage V1 at the terminals of the supply B1;

the voltage V2 at the terminals of the supply B2; and

the voltage Ve at the inputs of the circuit PD1 just downstream of the diodes D1 to D4 and the fuses F1 to F4.

FIG. 1 represents the state that these switches assume when each power supply B1, B2 is operating normally. The control unit CU1 detects that Ve has a value (approximately 47 V) lower than V1 and V2 (approximately 48 V), i.e. that the diodes D1 to D4 are conducting. It closes the switches SW1 and SW2 and opens the switch SW3 in order for the capacitors SC1 and SC2 both to be connected in parallel to the outputs of the circuit PD1. The capacitors SC1 and SC2 are charged to the voltage of the supplies B1 and B2 (approximately 47 V) via the diodes D1 to D4. During this normal operation, they add a certain filtering effect to that of the capacitors C1 to Cn.

FIG. 2 is a diagram of the same embodiment of the prior art circuit, showing the state of the switches SW1, SW2, SW3 when each power supply B1, B2 has temporarily failed because of a short-circuit across one of the loads other than the load L. In the protection circuit PD1, the voltages V1 and V2 suddenly fall below the voltage Ve and the diodes D1, D2, D3, D4 cease to conduct and isolate the circuit PD1 from the supplies B1 and B2, which are short-circuited. They prevent the short-circuit discharging the capacitors SC1 and SC2. The voltage at the terminals of the capacitors SC1, SC2, C1 to Cn begins to fall progressively as they discharge to supply power to the converter CV.

The diode pair D1-D2 ceases to conduct when the voltage Ve (approximately 47 V) rises above V1. When the voltage Ve rises above V2, the diode pair D3-D4 ceases to conduct. When Ve rises above V1 and V2 the control unit CU1 concludes that there is a failure of the supplies B1 and B2 and opens the switches SW1 and SW3. After a delay necessary for these switches to open (for example 10 microseconds (μs)), it closes the switch SW2 to connect the capacitors SC1 and SC2 in series. This combination then shunts the outputs of the circuit PD1 and in theory (if the filter capacitors C1 to Cn were not present) supplies a voltage equal to the sum of the voltage to which the capacitor C1 is charged and the voltage to which the capacitor C2 is charged at the time of switching, which voltage sum is approximately 94 V. This voltage is in reality attenuated by the filter capacitors C1 to Cn. The top-up charging of these capacitors C1 to Cn yields an initial voltage of 82 V in one embodiment. This voltage then falls, but supplies the load L at a voltage greater than 36 V for at least 5 milliseconds (ms) (this delay is set by the Advanced Telecommunication Computing Architecture (ATCA)), 36 V being the minimum value necessary for correct operation of the converter CV in the present example.

The time constants are selected so that the three transistors that constitute the switches SW1, SW2, SW3 are not able to conduct simultaneously.

When the short-circuit is no longer present, the control unit CU1 detects that the voltage Ve remains at a value (approximately 47 V) that is again higher than V1 and V2 for a duration greater than a fixed threshold (for example 5 ms). It first opens the switch SW3. After a delay necessary for this opening (for example 100 μs), it closes the switches SW1 and SW2 so that the capacitors SC1 and SC2 are both connected in parallel to the outputs of the circuit PD1. They are charged to the voltage of the supplies V1 and V2 (approximately 47 V) via the diodes D1 to D4.

FIG. 3 is a block diagram of a variant PD1′ of the above embodiment of the prior art circuit. The control unit CU1 is replaced by a control unit CU1′ which has only one pair of inputs, connected to the cathodes of the diodes D1 and D3 and to the anodes of the diodes D2 and D4. If the voltage Ve falls below a fixed threshold value of 41 V, the control unit CU1′ opens the switches SW1 and SW3. After a delay necessary for this opening (for example 10 μs), it closes the switch SW2 to connect the capacitors SC1 and SC2 in series. This combination then shunts the outputs of the circuit PD1 and supplies a voltage equal to the sum of the voltages to which the capacitors C1 and C2 are charged at the moment of switching, which is initially about 82 V.

When the short-circuit is no longer present, the control unit CU1′ detects that the voltage Ve retains a value (approximately 47 V) that is again higher than the threshold value (41 V) for a duration greater than a fixed threshold (for example 5 ms). It first opens the switch SW3. After a delay necessary for this opening (for example 100 μs), it closes the switches SW1 and SW2 to connect the capacitors SC1 and SC2 in parallel to the outputs of the circuit PD1. These are capacitors charged to the voltage of the supplies B1 and B2, which is approximately 47 V, via the diodes D1 to D4.

FIG. 4 is a block diagram of one embodiment PD2 of a protection circuit of the invention. It is simpler than the prior art circuit because it includes only one electronic switch SW3. It differs from the prior art circuit in that the electronic switches SW1 and SW2 are replaced by resistors R1 and R2, respectively. The control unit CU2 is analogous to the control unit CU1 of the embodiment PD1, for example, but with only one output, which controls the switch SW3.

FIG. 4 shows the state of the switch SW3 when each power supply B1, B2 is operating normally. The control unit CU2 detects that the voltage Ve has a value (approximately 47 V) less than V1 and V2 (approximately 48 V), meaning that the diodes D1 to D4 are conducting. The control unit causes the switch SW3 to remains open in order for the capacitors SC1 and SC2 both to be connected in series to the outputs of the circuit PD1 by the resistors R1 and R2, respectively. The capacitors SC1 and SC2 charge to the voltage supplied by the supplies B1 and B2, which is approximately 47 V, via the diodes D1 to D4.

FIG. 5 is a block diagram of this embodiment PD2 in the condition it assumes when the power supply B1, B2 has a transient fault caused by a short-circuit on one of the loads other than the load L. In the protection circuit PD2, the voltages V1 and V2 are suddenly less than the voltage Ve, and the diodes D1, D2, D3, D4 cease to conduct and isolate the circuit PD2 from the supplies B1 and B2 which are short-circuited. They prevent the short-circuit discharging the capacitors SC1 and SC2. The voltage across the capacitors SC1, SC2, C1 to Cn begins to fall progressively, as they discharge to supply power to the converter CV.

The diode pair D1-D2 ceases to conduct if the voltage Ve (approximately 47 V) rises above V1. The diode pair D3-D4 ceases to conduct if the voltage Ve rises above V2. If Ve rises above V1 and V2, the control unit CU2 concludes that there is a power supply failure in respect of the supplies B1 and B2 and closes the switch SW3. The capacitors SC1 and SC2 are then connected in series. The resistor is in parallel with the capacitor SC2. The resistor R2 is in parallel with the capacitor SC1. The time constants R2×SC1 and R1×SC2 are made much higher than 5 ms so that the discharge caused by these resistors is negligible.

The series-connected combination of the two capacitors SC1-SC2 then shunts the outputs of the circuit PD1 and supplies a voltage equal to the sum of the voltage to which the capacitor C1 is charged and the voltage to which the capacitor C2 is charged at the time of switching, which is initially 82 V.

When the short-circuit is no longer present, the control unit CU2 detects that the voltage Ve retains a value (approximately 47 V) that is again higher than V1 and V2 for a duration exceeding a fixed threshold (for example 5 ms). It opens the switch SW3. The capacitors SC1 and SC2 again shunt the outputs of the circuit PD2. They are charged to the voltage of the supplies B1 and B2, i.e. approximately 47 V, via the diodes D1 to D4.

The control unit CU1′ described with reference to FIG. 3 could also be used to control the switch SW3 of this second embodiment, instead of the unit CU2.

FIG. 6 is a block diagram of a variant PD3 of this embodiment enabling the use of storage capacitors SC1 and SC2 designed for a lower service voltage, which significantly reduces their cost and their bulk. To this end, a Zener diode Z1 shunts the capacitor C1 and a Zener diode Z2 shunts the capacitor C2. The Zener diode Z1 and the resistor R1 charge the capacitor C1, limiting the charging voltage to 47 V. Similarly, the Zener diode Z2 and the resistor R2 charge the capacitor C2 with the charging voltage limited to 47 V.

One example uses resistors R1=R2=10 kilohms (kΩ) and storage capacitors SC1=SC2=220 μf designed for an operating voltage of 50 V rather than 80 V or 100 V in the absence of Zener diodes.

For the variants described above, the capacitances of the storage capacitors SC1 and SC2 are selected as a function of:

the duration of the power supply failure;

the minimum voltage necessary for the converter CV;

the maximum voltage that the converter CV can withstand;

the maximum consumption of the load L; and

the capacitances of the filter capacitors C1 to Cn.

For example, for the variants described above with reference to FIGS. 1 to 5, and for:

a failure duration equal to 5 ms;

a minimum voltage equal to 36 V;

a maximum voltage equal to 72 V;

a capacitor charge voltage Vᵢₙ equal to 43 V at triggering time (on detecting failure of the supplies B1 and B2);

a maximum consumption equal to 195 W; and

a total capacitance of the filter capacitors C1 to Cn equal to 220 μf;

two capacitors SC1 and SC2 that may be used each have a capacitance of 680 μf. The voltage V_{BOOST} actually supplied by the two capacitors in series just after connecting them in series is then 69 V.

More generally, if C denotes the capacitance of each of the capacitors SC1 and SC2 and if the total capacitance of the filter capacitors C1 to Cn is equal to n×C, it can be demonstrated that the voltage V_{BOOST} really supplied by the capacitors in series, just after connecting them in series, is given by the formula:

$${V}_{BOOST} = \frac{n + 1}{n + 1 / 2} {V}_{i n}$$

in which Vᵢₙ is the capacitor charge voltage at triggering time (on detecting failure of the supplies B1 and B2).

It can also be demonstrated that the total capacitance Cₜₒₜ of SC1 in series with SC2 and of C1 to Cn necessary to overcome a failure of duration Δt with a load L consuming a power P is equal to:

$${C}_{tot} = \frac{2 \cdot P \cdot Δ t}{{V}_{BOOST}^{2} = {V}_{min}^{2}}$$

in which Vₘᵢₙ is the minimum voltage needed for the converter CV to function.

From this the capacitance C of each capacitor SC1 and SC2 is deduced:

$$C = \frac{{C}_{tot}}{n + 1 / 2}$$

The maximum duration of a failure that can be supported may be also be calculated from the formula:

$$Δ {t}_{max} = {C}_{tot} \frac{( {V}_{BOOST}^{2} - {V}_{min}^{2} )}{2 P}$$

The implementation of the electronic switches SW1, SW2, SW3 is evident for the person skilled in the art. They conventionally comprise MOS transistors. The supply switching circuit consisting of the diodes D1 to D4 can also be implemented by MOS transistors.

1. A protection circuit (PD2; PD3) enabling a load (L) to withstand a transient power supply failure, the circuit comprising:
inputs connected to at least one electrical power supply (B1, B2) and outputs connected to the load (L); and
at least two storage capacitors (SC1, SC2), first switching means (D1 to D4, SW3) and control means (CU2) for the first switching means such that the two storage capacitors are:
connected in parallel to at least one power supply (B1, B2) when at least one power supply is operating normally; and
isolated from any power supply (B1, B2) and connected in series to the outputs of the circuit (PD2) when no power supply (B1, B2) is operating normally; and the circuit being characterized in that:
a first storage capacitor (SC1) has a first terminal connected to a positive output of the circuit and a second terminal connected to the negative output of the circuit by a first resistor (R1);
a second storage capacitor (SC2) has a first terminal connected to the negative output of the circuit and a second terminal connected to the positive output of the circuit by a second resistor (R2); and
an electronic switch (SW3) connects the second terminal of the first capacitor (SC1) to the second terminal of the second storage capacitor (SC2); and
in that the first control means (CU2) include control means for commanding the switches (SW3) such that the switch (SW3) closes when no power supply is operating normally and the switch (SW3) opens when at least one power supply is operating normally.

2. A circuit according to claim 1, characterized in that it further comprises two Zener diodes (Z1, Z2) shunting respective storage capacitors (SC1, SC2) to limit their respective charge voltages to a value less than the voltage of a power supply (B1, B2).

3. A circuit according to claim 1, characterized in that it further comprises a slow-start circuit (SSC) between each power supply (B1, B2) and the storage capacitors (SC1, SC2).

4. A circuit according to claim 1, characterized in that it further comprises second switching means (D1, D2, D3, D4) between each power supply (B1, B2) and the storage capacitors (SC1, SC2) adapted to prevent a short-circuit across a power supply (B1, B2) discharging the storage capacitors (SC1, SC2).
